(19) United States
(12) Patent Application Publication
(10) Pub. No.: US 2020/0248589 A1
(43) Pub. Date: Aug. 6, 2020

(54) Oval Steam Turbine Casing

(71) Applicant: Elliott Company, Jeannette, PA (US)

(72) Inventor: Paul T. Smith, Export, PA (US)

(21) Appl. No.: 16/263,844

(22) Filed: Jan. 31, 2019

(51) Int. Cl. F01D 25/24; F01D 25/28

(52) U.S. Cl. CPC F01D 25/243; F05D 2250/14; F05D 2240/14; F01D 25/28

(57) ABSTRACT

A steam turbine may include a casing defining an interior cavity, wherein the casing comprises a first casing half and a second casing half, which are connected to one another to form the casing, wherein an interior surface of the first casing half has a first portion with a first curvature and a second portion with a second curvature, wherein the first curvature and the second curvature are different, and wherein an interior surface of the second casing half has a first portion with a first curvature and a second portion with a second curvature, wherein the first curvature and the second curvature are different. An interior surface of the casing may have a substantially oval-shaped cross-section. Internal pressure acting on the oval interior surface allows better sealing at the split line.

### BACKGROUND OF THE INVENTION

### Field of the Invention

The present disclosure is directed to, generally, a steam turbine and, more particularly, to a casing for a steam turbine.

### Description of Related Art

Turbomachines, such as steam turbines, gas turbines, centrifugal flow compressors, and axial flow compressors, may be utilized in various industries. Turbines, in particular, have a widespread use in power stations, jet engine applications, gas turbines, and automotive applications. Steam turbines and centrifugal flow compressors are also commonly used in large-scale industrial applications, such as ethylene plants, oil refineries, and power generation.

Steam turbines are devices that extract thermal energy from pressurized steam and use it to conduct mechanical work on a rotating output shaft. Multi-stage steam turbines are well known in the art. A typical multi-stage steam turbine includes a turbine casing that accommodates a series of diaphragms and a rotor in the form of a shaft with blades. The main purpose of the casing is to contain the high internal pressure in the turbine. Many steam turbines have a casing with a circular cross-sectional shape. A steam turbine casing must contain high internal pressure and risk experiencing leakage that can lead to explosive and dangerous results.

### SUMMARY OF THE INVENTION

In view of the foregoing, there is a current need for a steam turbine that includes a casing design that enhances the steam turbine's ability to seal a split line flange to contain internal pressures in the steam turbine. There is also a current need for a steam turbine that includes a casing design that increases lateral forces on the casing to create a stronger seal at a split line in a flange of the steam turbine.

In one example of the present disclosure, a steam turbine may include a casing defining an interior cavity, wherein the casing comprises a first casing half and a second casing half, which are connected to one another to form the casing, wherein an interior surface of the first casing half has a first portion with a first curvature and a second portion with a second curvature, wherein the first curvature and the second curvature are different, and wherein an interior surface of the second casing half has a first portion with a first curvature and a second portion with a second curvature, wherein the first curvature and the second curvature are different.

In another example of the present disclosure, the first casing half and the second casing half may be connected at a split line. The first casing half and the second casing half may be mechanically connected to one another. At the split line, an internal pressure causes edges of each of the first casing half and the second casing half to rotate towards one another to create a seal. The first and second casing halves each may have an inner surface including at least one flat portion and a substantially curved portion. The first and second casing halves may be separable from one another when not connected to one another. The first and second casing halves each may have an inner surface including a first flat portion, a second flat portion, and a substantially curved portion. The substantially curved portion of the first and second casing halves may be positioned between the first flat portion and the second flat portion. The first flat portions and the second flat portions of the first and second casing halves each may have a length ranging from 0.1 inches to 3 inches. The inner surfaces of the first casing half and the second casing half may form a substantially oval-shaped cross section.

In another example of the present disclosure, a steam turbine may include a casing defining an interior cavity. The casing may include a first casing half and a second casing half, which are connected to one another to form the casing. The first and second casing halves each may have an inner surface including at least one flat portion and a substantially curved portion.

In another example of the present disclosure, the first casing half and the second casing half may be connected at a split line. The first casing half and the second casing half may be mechanically connected to one another. At the split line, internal pressure may cause edges of each of the first casing half and the second casing half to rotate towards one another to create a seal. The first and second casing halves may be separable from one another when not connected to one another. The at least one flat portion of the first and second casing halves may include a first flat portion and a second flat portion. The substantially curved portion of the first and second casing halves may be positioned between the first flat portion and the second flat portion. The first flat portions and the second flat portions of the first and second casing halves each may have a length ranging from 0.1 inches to 3 inches. The inner surfaces of the first casing half and the second casing half may form a substantially oval-shaped cross section. The inner surfaces of the first and second casing halves may have corresponding shapes.

The present invention is also disclosed in the following clauses.

Clause 1: A steam turbine, comprising: a casing defining an interior cavity, wherein the casing comprises a first casing half and a second casing half, which are connected to one another to form the casing, wherein an interior surface of the first casing half has a first portion with a first curvature and a second portion with a second curvature, wherein the first curvature and the second curvature are different, and wherein an interior surface of the second casing half has a first portion with a first curvature and a second portion with a second curvature, wherein the first curvature and the second curvature are different.

Clause 2: The steam turbine of Clause 1, wherein the first casing half and the second casing half are connected at a split line.

Clause 3: The steam turbine of Clause 1 or 2, wherein the first casing half and the second casing half are mechanically connected to one another.

Clause 4: The steam turbine of Clause 2, wherein, at the split line, an internal pressure causes flat edges of each of the first casing half and the second casing half to rotate towards one another to create a seal.

Clause 5: The steam turbine of any of Clauses 1-4, wherein the inner surfaces of the first casing half and the second casing half comprise at least one flat portion and a substantially curved portion.

Clause 6: The steam turbine of any of Clauses 1-5, wherein the first and second casing halves are separable from one another when not connected to one another.

Clause 7: The steam turbine of any of Clauses 1-6, wherein the inner surfaces of the first casing half and the second casing half comprise a first flat portion, a second flat portion, and a substantially curved portion.

Clause 8: The steam turbine of Clause 7, wherein the substantially curved portion of the first and second casing halves is positioned between the first flat portion and the second flat portion.

Clause 9: The steam turbine of Clause 7 or 8, wherein the first flat portions and the second flat portions of the first and second casing halves each have a length ranging from 0.1 inches to 3 inches.

Clause 10: The steam turbine of any of Clauses 1-9, wherein the inner surfaces of the first casing half and the second casing half form a substantially oval-shaped cross section.

Clause 11: A steam turbine, comprising: a casing defining an interior cavity, wherein the casing comprises a first casing half and a second casing half, which are connected to one another to form the casing, and wherein the first and second casing halves each have an inner surface comprising at least one flat portion and a substantially curved portion.

Clause 12: The steam turbine of Clause 11, wherein the first casing half and the second casing half are connected at a split line.

Clause 13: The steam turbine of Clause 11 or 12, wherein the first casing half and the second casing half are mechanically connected to one another.

Clause 14: The steam turbine of Clause 12, wherein, at the split line, internal pressure causes flat edges of each of the first casing half and the second casing half to rotate towards one another to create a seal.

Clause 15: The steam turbine of any of Clauses 11-14, wherein the first and second casing halves are separable from one another when not connected to one another.

Clause 16: The steam turbine of any of Clauses 11-15, wherein the at least one flat portion of the first and second casing halves comprises a first flat portion and a second flat portion.

Clause 17: The steam turbine of Clause 16, wherein the substantially curved portion of the first and second casing halves is positioned between the first flat portion and the second flat portion.

Clause 18: The steam turbine of Clause 16 or 17, wherein the first flat portions and the second flat portions of the first and second casing halves each have a length ranging from 0.1 inches to 3 inches.

Clause 19: The steam turbine of any of Clauses 11-18, wherein the inner surfaces of the first casing half and the second casing half form a substantially oval-shaped cross section.

Clause 20: The steam turbine of any of Clauses 11-19, wherein the inner surfaces of the first and second casing halves have corresponding shapes.

### BRIEF DESCRIPTION OF THE DRAWINGS

FIG. 1 is a perspective view of a steam turbine according to one example of the present disclosure;

FIG. 2 is a cross-sectional view of the steam turbine of FIG. 1 along line A-A;

FIG. 3 is a cross-sectional view of a steam turbine with a different cross-sectional shape according to one example of the present disclosure;

FIG. 4 is a cross-sectional view of a steam turbine with a different cross-sectional shape according to one example of the present disclosure; and

FIG. 5 is a cross-sectional view of a steam turbine with a different cross-sectional shape according to one example of the present disclosure.

### DESCRIPTION OF THE INVENTION

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply examples and should not be considered as limiting.

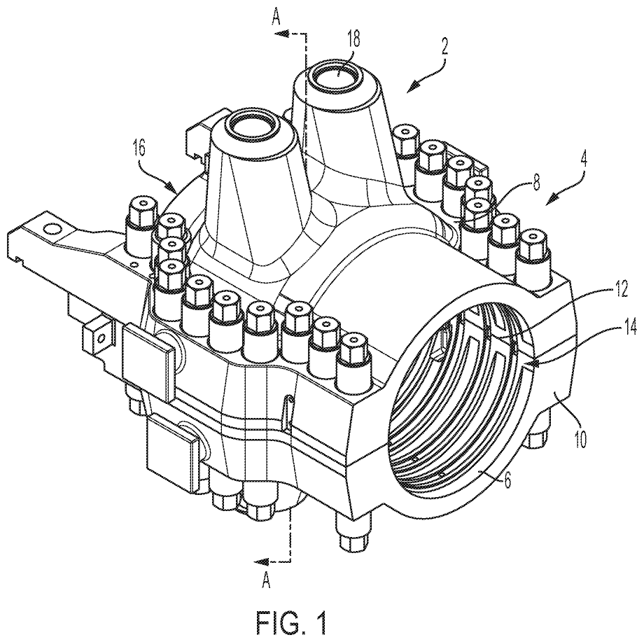

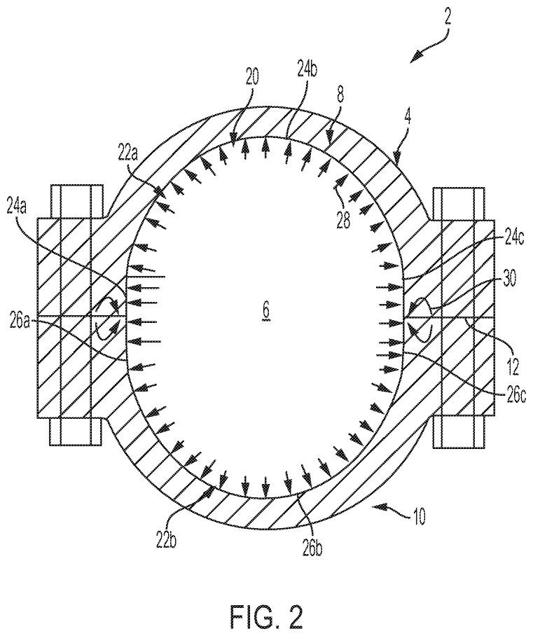

The present disclosure is directed to, in general, a steam turbine and, more particularly, a casing design for a steam turbine. Certain preferred and non-limiting aspects of the components of the system are illustrated in FIGS. 1 and 2. In one example, the disclosure is directed to a steam turbine casing having an oval cross-sectional shape. While the present disclosure is primarily directed to steam turbines, it is to be understood that these concepts discussed herein can also be applied to other turbomachines, including centrifugal flow compressors and axial flow compressors, among others.

With reference to FIGS. 1 and 2, a steam turbine 2 according to one example of the present disclosure is illustrated and described. The steam turbine 2 may include a casing 4 that defines an interior cavity 6 that extends along a longitudinal axis of the casing 4. In one example, the casing 4 may be a split two-piece casing that includes a first casing half 8 and a second casing half 10. The first and second casing halves 8, 10 may be assembled together to form the casing 4 for the steam turbine. The first and second casing halves 8, 10 may be operatively connected together using any mechanical arrangement, including a bolted arrangement, a latch arrangement, or any other arrangement that will operatively connect the casing halves 8, 10 together. It is also contemplated that the casing halves 8, 10 can be disconnected from one another so as to be separated from one another. Upon connection, the casing halves 8, 10 are configured to define the interior cavity 6 formed by the casing 4. In one example, an output shaft (not shown) is positioned within and extends through the interior cavity 6 of the casing 4.

As shown in FIGS. 1 and 2, when assembled, the casing halves 8, 10 come into contact with one another at a split line 12. In one example, the casing halves 8, 10 come into contact with one another at a horizontal split line. It is also contemplated that the casing halves 8, 10 may come into contact with one another at a vertical split line or any other angled split line. Once assembled, a seal is created by the casing halves 8, 10 at the split line 12 to ensure no internal pressures from the steam contained in the casing 4 can escape from the interior cavity 6. In one example, the split line 12 extends from a downstream end 14 of the casing 4 to an upstream end 16 of the casing 4. At least one inlet 18 for the interior cavity 6 may be provided on the first and second casing halves 8, 10, and the downstream end 14 of the casing 4 may define an outlet for the interior cavity 6.

With reference to FIG. 2, in one example of the present disclosure, the casing 4 includes an inner surface 20 that has an oval-shaped cross section. In particular, the inner surface 22a, 22b of each casing half 8, 10 forms one half of the oval shape to create the oval-shaped cross section of the casing 4. In one example, the inner surface 22a of the first casing half 8 and the inner surface 22b of the second casing half 10 have a corresponding or similar shape. In one example, the first casing half 8 includes a first straight portion 24a, a substantially curved portion 24b, and a second straight portion 24c. It is contemplated that the first and second straight portions 24a, 24c may have a first curvature, while the substantially curved portion 24b has a second curvature different from the first curvature. The substantially curved portion 24b is positioned between the first straight portion 24a and the second straight portion 24c. In one example, the second casing half 10 includes a first straight portion 26a, a substantially curved portion 26b, and a second straight portion 26c. It is contemplated that the first and second straight portions 26a, 26c may have a first curvature, while the substantially curved portion 26b has a second curvature different from the first curvature. The substantially curved portion 26b is positioned between the first straight portion 26a and the second straight portion 26c. When the casing halves 8, 10 are formed together, the first straight portion 24a of the first casing half 8 and the first straight portion 26a of the second casing half 10 contact one another to create a larger straight portion within the casing 4. Likewise, when the casing halves 8, 10 are formed together, the second straight portion 24c of the first casing half 8 and the second straight portion 26c of the second casing half 10 contact one another to create a larger straight portion within the casing 4. When fully assembled, the first straight portions 24a, 26a, the substantially curved portions 24b, 26b, and the second straight portions 24c, 26c of the casing halves 8, 10 form a substantially oval-shaped cross-section within the interior cavity 6 of the casing 4. It is contemplated that the length of the straight portions 24a, 24c, 26a, 26c may be adjusted depending on the internal pressures and overall casing dimensions that are provided in the interior cavity 6 to ensure an effective sealing at the split line 12. In one example of the present disclosure, the straight portions 24a, 24c, 26a, 26c may each extend between 0.1 inches and 3.0 inches. It is contemplated, however, that alternative dimensions for the straights portions 24a, 24c, 26a, 26c may be used depending on the specific internal pressure and overall casing dimensions of the particular steam turbine. As the length of the straight portions 24a, 24c, 26a, 26c is increased, the sealing pressure created at the split line 12 also increases.

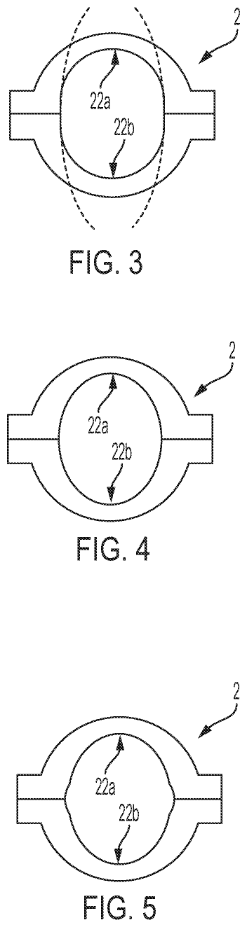

With reference to FIGS. 3-5, the inner surfaces 22a, 22b of the first and second casing halves 8, 10 may form a cross-sectional shape that results in a lateral force parallel to the surface that is being sealed. For example, the inner surfaces 22a, 22b of the first and second casing halves 8, 10 may have substantially flat portions, curved portions, elliptical portions, or any other suitable shape to provide these lateral forces. In one example of the present disclosure, the inner surface 22a of the first casing half 8 may include a first portion that includes a first curvature and a second portion that includes a second curvature, in which the first and second curvatures are different from one another. In one example of the present disclosure, the inner surface 22b of the second casing half 8 may include a first portion that includes a first curvature and a second portion that includes a second curvature, in which the first and second curvatures are different from one another.

As shown in FIG. 2, internal pressure (represented by arrows 28) within the interior cavity 6 of the casing 4 creates an outward force on the inner surface 20 of the casing 4, which can lead to leakage from the casing 4. By utilizing an oval-shaped cross section for the casing 4, the potential for leakage is greatly reduced. Due to the straight portions 24a, 26a, 24c, 26c that are used with the casing halves 8, 10, improved sealing is achieved at the split line 12 of the casing 4. By providing the straight portions 24a, 26a, 24c, 26c above and below the split line 12, lateral forces are increased on the casing 4. Force equals pressure times the area of a surface in a direction perpendicular to the surface. Therefore, the larger the area, the larger the lateral force. Due to the increased lateral forces, as the casing halves 8, 10 are connected to one another, the internal edges of the straight portions 24a, 24c, 26a, 26c, rotate in towards one another (as denoted by arrows 30), creating a stronger seal at the inner edge of the split line 12. Unlike steam turbines with a split casing that has a circular cross-sectional shape, the straight portions 24a, 24c, 26a, 26c of the casing halves 8, 10 of the steam turbine 2 of the present disclosure help to increase the sealing capabilities of the casing 4 at the split line 12. The steam turbines with a circular cross-sectional shape do not provide the same increased sealing capabilities at the split line that are provided by the lateral forces in the present disclosure.

While several aspects of the steam turbine 2 are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The invention described hereinabove is defined by the appended claims and all changes to the invention that fall within the meaning and range of equivalency of the claims are to be embraced within their scope.

The invention claimed is:

1. A steam turbine, comprising:
a casing defining an interior cavity,
wherein the casing comprises a first casing half and a second casing half, which are connected to one another to form the casing,
wherein an interior surface of the first casing half has a first portion with a first curvature and a second portion with a second curvature, wherein the first curvature and the second curvature are different, and
wherein an interior surface of the second casing half has a first portion with a first curvature and a second portion with a second curvature, wherein the first curvature and the second curvature are different.

2. The steam turbine of claim 1, wherein the first casing half and the second casing half are connected at a split line.

3. The steam turbine of claim 1, wherein the first casing half and the second casing half are mechanically connected to one another.

4. The steam turbine of claim 2, wherein, at the split line, an internal pressure causes flat edges of each of the first casing half and the second casing half to rotate towards one another to create a seal.

5. The steam turbine of claim 1, wherein the inner surfaces of the first casing half and the second casing half comprise at least one flat portion corresponding to the first portion and a substantially curved portion corresponding to the second portion.

6. The steam turbine of claim 1, wherein the first and second casing halves are separable from one another when not connected to one another.

7. The steam turbine of claim 1, wherein the inner surfaces of the first casing half and the second casing half comprise a first flat portion, a second flat portion, and a substantially curved portion.

8. The steam turbine of claim 7, wherein the substantially curved portion of the first and second casing halves is positioned between the first flat portion and the second flat portion.

9. The steam turbine of claim 7, wherein the first flat portions and the second flat portions of the first and second casing halves each have a length ranging from 0.1 inches to 3 inches.

10. The steam turbine of claim 1, wherein the inner surfaces of the first casing half and the second casing half form a substantially oval-shaped cross section.

11. A steam turbine, comprising:
a casing defining an interior cavity,
wherein the casing comprises a first casing half and a second casing half, which are connected to one another to form the casing, and
wherein the first and second casing halves each have an inner surface comprising at least one flat portion and a substantially curved portion.

12. The steam turbine of claim 11, wherein the first casing half and the second casing half are connected at a split line.

13. The steam turbine of claim 11, wherein the first casing half and the second casing half are mechanically connected to one another.

14. The steam turbine of claim 12, wherein, at the split line, an internal pressure causes flat edges of each of the first casing half and the second casing half to rotate towards one another to create a seal.

15. The steam turbine of claim 11, wherein the first and second casing halves are separable from one another when not connected to one another.

16. The steam turbine of claim 11, wherein the at least one flat portion of the first and second casing halves comprises a first flat portion and a second flat portion.

17. The steam turbine of claim 16, wherein the substantially curved portion of the first and second casing halves is positioned between the first flat portion and the second flat portion.

18. The steam turbine of claim 16, wherein the first flat portions and the second flat portions of the first and second casing halves each have a length ranging from 0.1 inches to 3 inches.

19. The steam turbine of claim 11, wherein the inner surfaces of the first casing half and the second casing half form a substantially oval-shaped cross section.

20. The steam turbine of claim 11, wherein the inner surfaces of the first and second casing halves have corresponding shapes.
